(19) United States
(12) Patent Application Publication
(10) Pub. No.: US 2023/0142947 A1
(43) Pub. Date: May 11, 2023

(54) SATELLITE COMMUNICATION EARTH STATION AND COMMUNICATION CONTROL METHOD

(71) Applicant: NIPPON TELEGRAPH AND TELEPHONE CORPORATION, Tokyo (JP)

(72) Inventors: Hiroki SHIBAYAMA, Musashino-shi, Tokyo (JP); Koichi HARADA, Musashino-shi, Tokyo (JP); Masaki SHIMA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 17/919,563

(22) PCT Filed: Apr. 21, 2020
(86) PCT No.: PCT/JP2020/017243

§ 371 Date: Oct. 18, 2022

(51) Int. Cl. H04B 7/185

(52) U.S. Cl. CPC H04B 7/18515

(57) ABSTRACT

Determination information necessary to determine accuracy of detection of a longitude, a latitude, and an altitude of an antenna is acquired, whether the accuracy of detection of the longitude, the latitude, and the altitude is in a necessary and sufficient level is determined in accordance with the acquired determination information, the longitude, the latitude, the altitude, the azimuth, and the inclination of the antenna are detected also after elapse of a predetermined time after the transmission of the radio wave from the antenna is stopped, and the antenna is driven to adjust the azimuth angle, the elevation angle, and the polarization angle of the antenna to the communication satellite in accordance with the longitude, the latitude, the altitude, the azimuth, and the inclination of the antenna detected after elapse of the predetermined time after the transmission of the radio wave from the antenna is stopped.

### TECHNICAL FIELD

The present disclosure relates to a satellite communication earth station and a communication control method.

### BACKGROUND ART

An existing satellite communication earth station that performs wireless communication with a communication satellite includes a global navigation satellite system (GNSS) receiver, an azimuth sensor, and an acceleration sensor and detects a latitude, a longitude, and an altitude where the satellite communication earth station is located, an azimuth, and an inclination of a ground surface.

The GNSS includes a system that receives radio waves from satellites to measure the position, such as a global positioning system (GPS) and a quasi-zenith satellite system (QZSS).

Also, the satellite communication earth station holds in advance the position (the latitude, the longitude, and the altitude) of the communication satellite in a satellite position storage unit and calculates a direction directed from the satellite communication earth station to the communication satellite (satellite direction) in accordance with the latitude, the longitude, and the altitude of the communication satellite that is a communication counterpart and the latitude, the longitude, and the altitude of the satellite communication earth station, the azimuth, and the inclination of the ground surface when the satellite communication earth station starts communication.

Then, the satellite communication earth station calculates a rotation angle of an azimuth angle control motor of an antenna, a rotation angle of an elevation angle control motor, and a rotation angle of a polarization angle control motor such that the antenna is directed to the direction of the communication satellite and performs setting to direct the antenna to the communication satellite. This allows the satellite communication earth station to communicate with the communication satellite (see PTL 1, for example).

### CITATION LIST

### Patent Literature

Patent Document 1: Japanese Patent No. 5592983

### SUMMARY OF THE INVENTION

### Technical Problem

A GNSS receiver included in the satellite communication earth station receives signals transmitted by a navigation satellite and calculates the latitude, the longitude, and the altitude of the satellite communication earth station. However, if the number of satellites from which signals can be received is small, for example, a difference (error) may be caused between the calculated latitude, the longitude, and the altitude of the satellite communication earth station and an actual position (the latitude, the longitude, and the altitude).

Also, the satellite communication earth station adjusts the direction of the antenna to the communication satellite before communication in accordance with the position of the satellite communication earth station. In other words, if a difference is caused between the calculated position of the satellite communication earth station and the actual position, then the satellite communication earth station cannot accurately direct the antenna to the communication satellite and cannot perform communication.

An object of the present disclosure is to provide a satellite communication earth station and a communication control method capable of preventing time taken to direct an antenna to a communication satellite from increasing due to calculation accuracy of the position of the satellite communication earth station.

### Means for Solving the Problem

A satellite communication earth station according to an aspect of the present disclosure for adjusting an azimuth angle, an elevation angle, and a polarization angle of an antenna to a communication satellite and then transmitting and receiving a radio wave between the antenna and the communication satellite includes a detection unit that detects a longitude, a latitude, an altitude, an azimuth, and an inclination of the antenna, a drive unit that drives the antenna to adjust the azimuth angle, the elevation angle, and the polarization angle of the antenna to the communication satellite in accordance with the longitude, the latitude, the altitude, the azimuth, or the inclination detected by the detection unit, a determination information acquisition unit that acquires determination information necessary to determine accuracy of detection of the longitude, the latitude, and the altitude of the antenna detected by the detection unit, a determination unit that determines whether the accuracy of detection of the longitude, the latitude, and the altitude detected by the detection unit is in a necessary and sufficient level in accordance with the determination information acquired by the determination information acquisition unit, and a stop processing unit that stops transmission of the radio wave from the antenna when the determination unit determines that the accuracy of detection of the longitude, the latitude, and the altitude is not in the necessary and sufficient level. The detection unit detects the longitude, the latitude, the altitude, the azimuth, and the inclination of the antenna also after elapse of a predetermined time after the stop processing unit stops the transmission of the radio wave from the antenna, and the drive unit drives the antenna to adjust the azimuth angle, the elevation angle, and the polarization angle of the antenna to the communication satellite in accordance with the longitude, the latitude, the altitude, the azimuth, and the inclination of the antenna detected by the detection unit after elapse of the predetermined time after the stop processing unit stops the transmission of the radio wave from the antenna.

A communication control method according to an aspect of the present disclosure for controlling communication of a satellite communication earth station for adjusting an azimuth angle, an elevation angle, and a polarization angle of an antenna to a communication satellite and then transmitting and receiving a radio wave between the antenna and the communication satellite includes detecting a longitude, a latitude, an altitude, an azimuth, and an inclination of the antenna, driving the antenna to adjust the azimuth angle, the elevation angle, and the polarization angle of the antenna to the communication satellite in accordance with the detected longitude, latitude, altitude, azimuth, or inclination, acquiring determination information necessary to determine accuracy of detection of the detected longitude, latitude, and altitude of the antenna, determining whether the accuracy of detection of the longitude, the latitude, and the altitude is in a necessary and sufficient level in accordance with the acquired determination information, stopping transmission of the radio wave from the antenna when it is determined that the accuracy of detection of the longitude, the latitude, and the altitude is not in the necessary and sufficient level, detecting the longitude, the latitude, the altitude, the azimuth, and the inclination of the antenna also after elapse of a predetermined time after the transmission of the radio wave from the antenna is stopped, and driving the antenna to adjust the azimuth angle, the elevation angle, and the polarization angle of the antenna to the communication satellite in accordance with the longitude, the latitude, the altitude, the azimuth, and the inclination of the antenna detected after elapse of the predetermined time after the transmission of the radio wave from the antenna is stopped.

### Effects of the Invention

The present disclosure allows for preventing time taken to direct the antenna to the communication satellite from increasing due to calculation accuracy of the position of the satellite communication earth station.

### BRIEF DESCRIPTION OF DRAWINGS

FIG. 1 is a diagram illustrating, as an example, an overview of a satellite communication system according to an embodiment.

FIG. 2 is a functional block diagram illustrating, as an example, an overview of functions that a satellite communication earth station has according to the embodiment.

FIG. 3 is a diagram illustrating, as an example, determination information acquired by a determination information acquisition unit.

FIG. 4 is a diagram illustrating, as an example, a threshold value held by a determination unit.

FIG. 5 is a flowchart illustrating an operation example of the satellite communication earth station according to the embodiment.

FIG. 6 is a diagram illustrating a hardware configuration example of the satellite communication earth station according to the embodiment.

### DESCRIPTION OF EMBODIMENTS

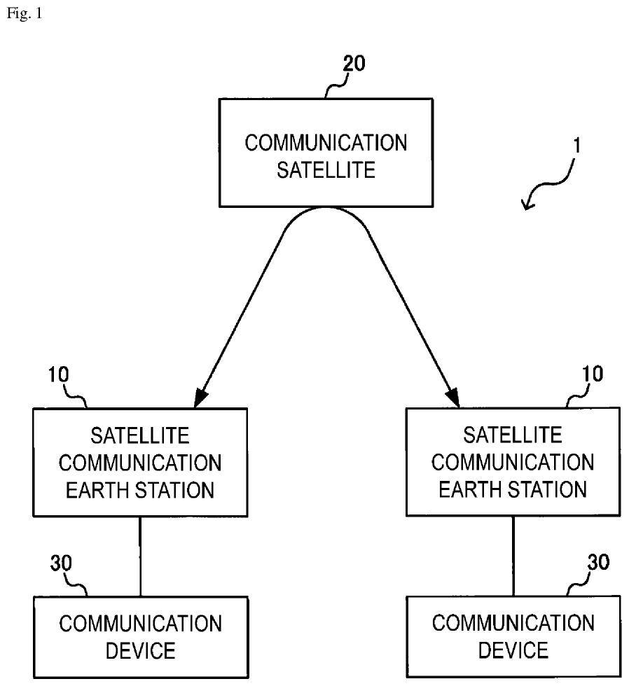

Hereinafter, an embodiment of a satellite communication system will be described using the drawings. FIG. 1 is a diagram illustrating, as an example, an overview of a satellite communication system 1 according to an embodiment. The satellite communication system 1 is, for example, a system in which a plurality of satellite communication earth stations 10 perform wireless communication via a communication satellite 20.

Also, communication devices 30 are connected to each satellite communication earth station 10. In other words, the satellite communication system 1 is a system that enables the plurality of communication devices 30 to perform communication via the satellite communication earth stations 10 and the communication satellite 20. In addition, the satellite communication earth stations 10 adjust azimuth angles, elevation angles, and polarization angles of antennas that the satellite communication earth stations 10 themselves include in accordance with the communication satellite 20 and then transmit and receive radio waves to and from the communication satellite 20.

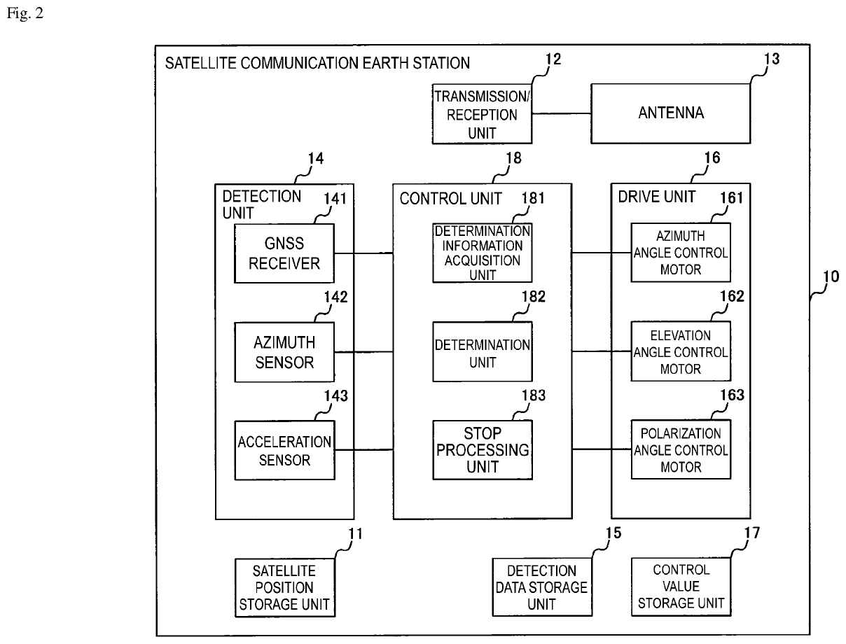

FIG. 2 is a functional block diagram illustrating, as an example, an overview of functions that each satellite communication earth station 10 has according to the embodiment. As illustrated in FIG. 2, the satellite communication earth station 10 includes a satellite position storage unit 11, a transmission/reception unit 12, an antenna 13, a detection unit 14, a detection data storage unit 15, a drive unit 16, a control value storage unit 17, and a control unit 18.

The satellite position storage unit 11 stores, for example, the position (the latitude, the longitude, and the altitude) of the communication satellite 20 (FIG. 1), which is a stationary satellite, in advance. Note that the communication satellite 20 is not limited to a stationary satellite and may be a moving satellite.

The transmission/reception unit 12 transmits and receives signals to and from the communication satellite 20 via the antenna 13. For example, the transmission/reception unit 12 modulates data transmitted from the satellite communication earth station 10 to the communication satellite 20 into a radio signal and outputs the radio signal to the antenna 13. Also, the transmission/reception unit 12 demodulates the radio signal received by the antenna 13 from the communication satellite 20.

Note that signals transmitted and received by the transmission/reception unit 12 include data (main signal) and control signals used to control line setting and the like among the plurality of satellite communication earth stations 10.

The antenna 13 is provided at an upper portion of the satellite communication earth station 10, for example, such that the azimuth angle, the elevation angle, and the polarization angle thereof become variable, and transmits and receives radio waves to and from the communication satellite 20.

The detection unit 14 includes, for example, a GNSS receiver 141, an azimuth sensor 142, and an acceleration (gravity) sensor 143.

The GNSS receiver 141 detects the latitude, the longitude, and the altitude of the antenna 13 or the satellite communication earth station 10 through reception of signals from navigation satellites, such as a GPS and a QZSS, for example, and outputs the detected latitude, the longitude, and the altitude to the control unit 18. For example, a GNSS such as a GPS specifies the reception position by simultaneously receiving GNSS signals from four or more navigation satellites.

The azimuth sensor 142 detects an azimuth in which the antenna 13 or the satellite communication earth station 10 is directed and outputs the detected azimuth to the control unit 18. The acceleration sensor 143 detects the inclination of the antenna 13 or the satellite communication earth station 10 with respect to an installation surface and outputs the detected inclination to the control unit 18.

Although it is assumed that the detection unit 14 detects each value regarding the antenna 13 here, the detection unit 14 may detect values regarding the satellite communication earth station 10 and regard the values substantially as values for the antenna 13 or may detect values that can be converted into values for the antenna 13.

Also, the detection unit 14 performs the detection at a predetermined cycle when the satellite communication earth station 10 performs communication with the communication satellite 20. Moreover, the detection unit 14 detects the latitude and the longitude, the azimuth, and the inclination of the antenna 13 even after elapse of a predetermined time after a stop processing unit 183, which will be described below, causes the transmission of radio waves from the antenna 13 to stop (detection process after elapse of time).

The detection data storage unit 15 stores the latitude, the longitude, the altitude, the azimuth, and the inclination detected by the detection unit 14. Note that because the detection unit 14 detects the latitude, the longitude, the altitude, the azimuth, and the inclination at the predetermined cycle when the satellite communication earth station 10 performs communication, the detection data storage unit 15 periodically stores each of the latitude, the longitude, the altitude, the azimuth, and the inclination detected by the detection unit 14.

The drive unit 16 includes an azimuth angle control motor 161, an elevation angle control motor 162, and a polarization angle control motor 163.

The azimuth angle control motor 161 drives the antenna 13 such that the azimuth (a rotation angle from the initial setting) in which the antenna 13 is directed is adjusted in accordance with the communication satellite 20 that is a target of communication in accordance with control performed by the control unit 18. The elevation angle control motor 162 drives the antenna 13 such that the elevation angle (a rotation angle from the initial setting) of the antenna 13 is adjusted in accordance with the communication satellite 20 that is a target of communication in accordance with control performed by the control unit 18. The polarization angle control motor 163 drives the antenna 13 such that the polarization angle (a rotation angle from the initial setting) of radio waves transmitted and received by the antenna 13 is adjusted in accordance with the communication satellite 20 that is a target of communication in accordance with control performed by the control unit 18.

For example, the drive unit 16 performs driving such that the azimuth angle, the elevation angle, and the polarization angle of the antenna 13 are adjusted in accordance with the communication satellite 20 based on the latitude, the longitude, and the altitude, the azimuth, and the inclination detected by the detection unit 14. Also, the drive unit 16 performs driving such that the azimuth angle, the elevation angle, and the polarization angle of the antenna 13 are adjusted in accordance with the communication satellite 20 based on the longitude and the latitude, the azimuth, and the inclination of the antenna 13 detected by the detection unit 14 even after elapse of predetermined time after the stop processing unit 183, which will be described below, causes the transmission of radio waves from the antenna 13 to stop (drive process after elapse of time). Moreover, the drive unit 16 may drive (adjust) the antenna 13 at a predetermined cycle when the satellite communication earth station 10 performs communication with the communication satellite 20.

The control value storage unit 17 stores each control value (a rotation angle from the initial setting) indicating the amount by which the drive unit 16 has driven the antenna 13.

The control unit 18 includes, for example, a determination information acquisition unit 181, a determination unit 182, and a stop processing unit 183 and controls each component constituting the satellite communication earth station 10. Also, it is assumed that the control unit 18 has a function of calculating a direction directed from the antenna 13 to the communication satellite 20 based on the latitude, the longitude, the altitude, the azimuth, and the inclination of the antenna 13 (or the satellite communication earth station 10).

The determination information acquisition unit 181 acquires determination information necessary to determine the accuracy of the detection of the longitude and the latitude of the antenna 13 detected by the detection unit 14. For example, the determination information acquisition unit 181 may acquire, as determination information necessary to determine the accuracy of GNSS positioning, at least any of the number of communication satellites that have received GNSS signals, reception levels of radio waves received from each communication satellite (reception intensity), and the elevation angles and the azimuth relative to the communication satellites.

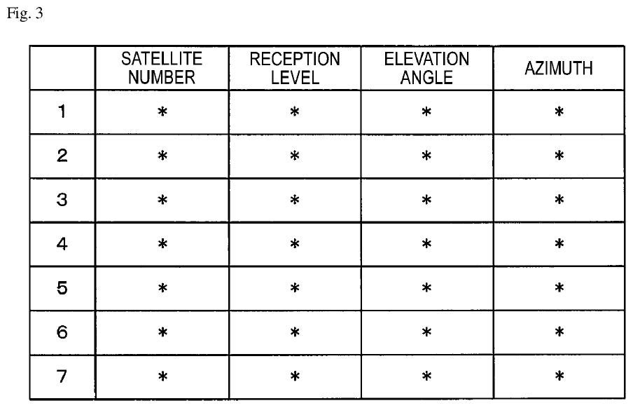

FIG. 3 is a diagram illustrating, as an example, determination information acquired by the determination information acquisition unit 181. As illustrated in FIG. 3, the determination information acquisition unit 181 acquires the number of communication satellites that receive GNSS signals by acquiring identification numbers (satellite numbers) of the communication satellites. Then, the determination information acquisition unit 181 acquires the radio wave reception level and the elevation angle and the azimuth relative to the communication satellites for each identification number of the communication satellites.

The determination unit 182 determines whether the accuracy of the detection of the longitude and the latitude detected by the detection unit 14 is in a necessary sufficient level based on the determination information acquired by the determination information acquisition unit 181. For example, the determination unit 182 determines whether the accuracy of the detection of the longitude and the latitude detected by the detection unit 14 is in a necessary sufficient level based on at least any of the number of communication satellites, from which the satellite communication earth station 10 receives radio waves, reception levels of radio waves received from the communication satellites, and the elevation angles and the azimuths relative to the communication satellites.

For example, the determination unit 182 holds a threshold value for determining whether the accuracy of the detection of the longitude and the latitude is in a necessary sufficient level and performs the determination using the threshold value.

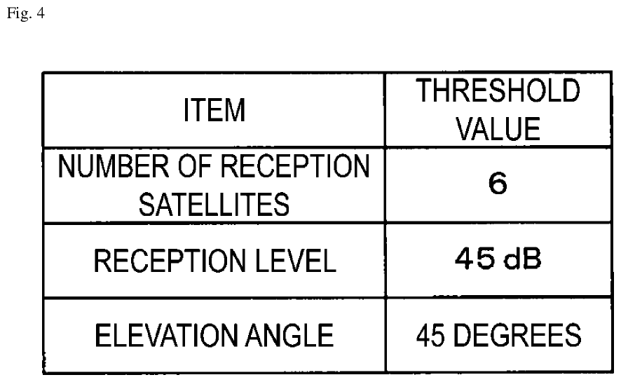

FIG. 4 is a diagram illustrating, as an example, the threshold value held by the determination unit 182. As illustrated in FIG. 4, the determination unit 182 holds a threshold value for each of the number of reception satellites, the reception level, and the elevation angle, for example.

For example, the determination unit 182 determines whether the number of communication satellites with reception levels of equal to or greater than 45 dB and with elevation angles of equal to or greater than 45 degrees is six or more and determines that the detection accuracy of the detection unit 14 is in a necessary sufficient level in a case where all values are equal to or greater than the threshold values.

Note that the satellite communication earth station 10 may image a zenith direction using a camera and determine whether the accuracy of the detection of the longitude and the latitude is in a necessary sufficient level using conditions of obstacles such as surrounding buildings and information regarding an imaging clock time.

The stop processing unit 183 causes the transmission of radio waves from the antenna 13 to stop in a case where the determination unit 182 determines that the accuracy of the detection of the longitude and the latitude is not in the necessary sufficient level.

Then, in a case where the accuracy of the detection of the longitude and the latitude is not in the necessary sufficient level (the measurement error of the satellite communication earth station is equal to or greater than a predetermined value), the control unit 18 performs control such that the drive unit 16 does not drive the antenna 13.

In other words, in a case where it is predicted to be impossible to accurately adjust the direction of the antenna 13 in accordance with the communication satellite 20 based on the result of the GNSS positioning, the satellite communication earth station 10 causes the processing of adjusting the direction relative to the antenna 13 to stop. Also, in a case where it is expected to be possible to accurately adjust the direction relative to the antenna 13, the satellite communication earth station 10 restarts the processing of adjusting the direction relative to the antenna 13 and shortens the final processing time.

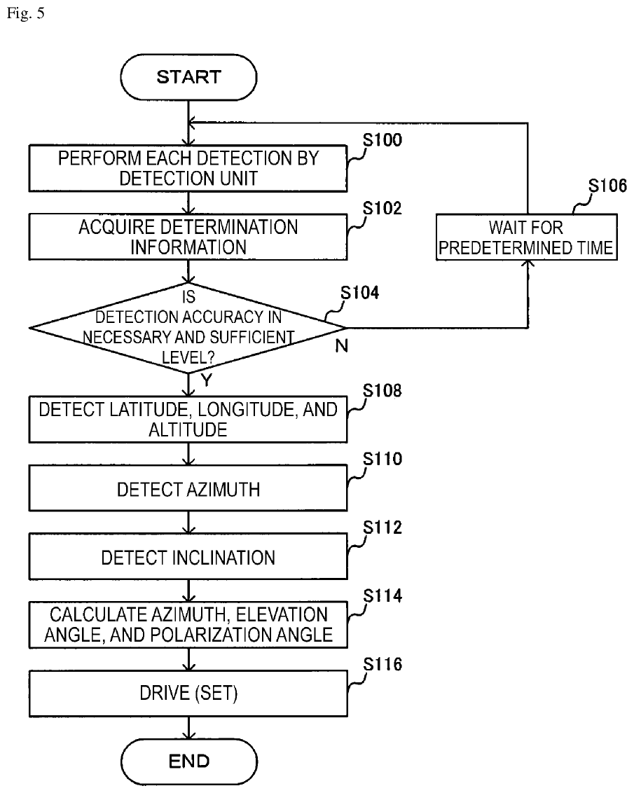

Next, an operation example of the satellite communication earth station 10 will be described. FIG. 5 is a flowchart illustrating an operation example of the satellite communication earth station 10 according to an embodiment.

As illustrated in FIG. 5, the detection unit 14 performs each kind of detection (S100), and the determination information acquisition unit 181 acquires the determination information (S102), in the satellite communication earth station 10.

Then, the determination unit 182 determines whether the detection accuracy is in a necessary sufficient level (S104) and moves on to processing in S106 in a case where it is determined that the detection accuracy is not in the necessary sufficient level (S104: No), or moves on to processing in S108 in a case where it is determined that the detection accuracy is in a necessary sufficient level (S104: Yes).

In the processing in S106, the detection unit 14 waits for elapse of a predetermined time after the stop processing unit 183 causes the transmission of radio waves from the antenna 13 to stop and returns to the processing in S100.

In the processing in S108, the GNSS receiver 141 detects the latitude, the longitude, and the altitude of the antenna 13 (S108), the azimuth sensor 142 detects the azimuth of the antenna 13 (S110), and the acceleration sensor 143 detects the inclination of the antenna 13 (S112), in the satellite communication earth station 10.

Then, the control unit 18 calculates a direction from the antenna 13 to the communication satellite 20 based on the detected latitude, longitude, and altitude, azimuth, and inclination of the antenna 13 (S114).

Thereafter, the drive unit 16 performs driving such that the azimuth angle, the elevation angle, and the polarization angle of the antenna 13 are adjusted in accordance with the communication satellite 20 (S116). In other words, the satellite communication earth station 10 sets the direction of the antenna 13 in accordance with the communication satellite 20.

In this manner, the satellite communication earth station 10 causes the transmission of radio waves from the antenna 13 to stop in a case where it is determined that the accuracy of the detection of the longitude and the latitude is not in a necessary sufficient level and performs driving such that the azimuth angle, the elevation angle, and the polarization angle of the antenna 13 are adjusted in accordance with the communication satellite 20 based on the longitude and the latitude, the azimuth, and the inclination of the antenna 13 detected by the detection unit 14 after elapse of a predetermined time. The satellite communication earth station 10 can thus prevent the time taken to direct the direction of the antenna 13 to the communication satellite 20 from increasing due to accuracy of calculating the position of the satellite communication earth station 10.

Also, the satellite communication earth station 10 may have a function of displaying the state of the antenna 13 and the state of each kind of processing to an operator.

Note that each function included in the satellite communication earth station 10, the communication satellite 20, and the communication device 30 may be partially or entirely configured with hardware or may be configured as a program to be executed by a processor such as a CPU.

In other words, the satellite communication system 1 according to the present disclosure can be achieved using a computer and the program, and it is possible to record the program in a storage medium or to provide the program through a network.

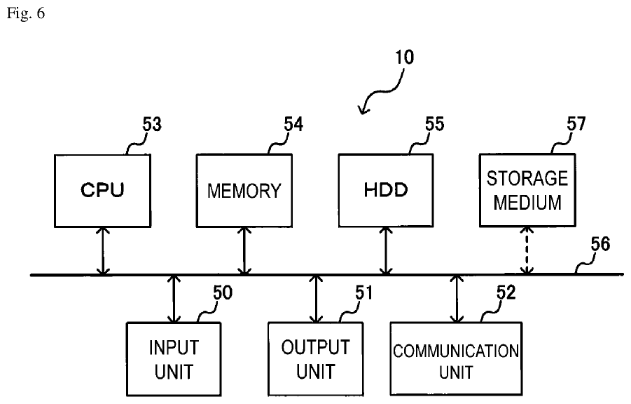

FIG. 6 is a diagram illustrating a hardware configuration example of the satellite communication earth station 10 according to the embodiment. As illustrated in FIG. 6, the satellite communication earth station 10 has functions of a computer with an input unit 50, an output unit 51, a communication unit 52, a CPU 53, a memory 54, and an HDD 55 connected via a bus 56, for example. Also, the satellite communication earth station 10 is adapted to be able to input and output data to and from the storage medium 57.

The input unit 50 is, for example, a keyboard, a mouse, and the like. The output unit 51 is, for example, a display device such as a display. The communication unit 52 is, for example, a wireless network interface.

The CPU 53 controls each component constituting the satellite communication earth station 10 and performs the aforementioned processing. The memory 54 and the HDD 55 store data. The storage medium 57 is adapted to be able to store a received program and the like that causes the functions included in the satellite communication earth station 10 to be executed. Note that the architecture constituting the satellite communication earth station 10 is not limited to the example illustrated in FIG. 6. Also, the communication satellite 20 and the communication device 30 may also include configurations similar to that of the satellite communication earth station 10.

### REFERENCE SIGNS LIST

1 Satellite communication system
10 Satellite communication earth station
11 Satellite position storage unit
12 Transmission/reception unit
13 Antenna
14 Detection unit
15 Detection data storage unit
16 Drive unit
17 Control value storage unit
18 Control unit
20 Communication satellite
30 Communication device
50 Input unit
51 Output unit
52 Communication unit
53 CPU
54 Memory
55 HDD
56 Bus
57 Storage medium
141 GNSS receiver
142 Azimuth sensor
143 Acceleration sensor
161 Azimuth angle control motor
162 Elevation angle control motor
163 Polarization angle control motor
181 Determination information acquisition unit
182 Determination unit
183 Stop processing unit

1. A satellite communication earth station for adjusting an azimuth angle, an elevation angle, and a polarization angle of an antenna to a communication satellite and then transmitting and receiving a radio wave between the antenna and the communication satellite, the satellite communication earth station comprising:
a detection unit configured to detect a longitude, a latitude, an altitude, an azimuth, and an inclination of the antenna;
a drive unit configured to drive the antenna to adjust the azimuth angle, the elevation angle, and the polarization angle of the antenna to the communication satellite in accordance with the longitude, the latitude, the altitude, the azimuth, or the inclination detected by the detection unit;
a determination information acquisition unit configured to acquire determination information necessary to determine accuracy of detection of the longitude, the latitude, and the altitude of the antenna detected by the detection unit;
a determination unit configured to determine whether the accuracy of detection of the longitude, the latitude, and the altitude detected by the detection unit is in a necessary and sufficient level in accordance with the determination information acquired by the determination information acquisition unit; and
a stop processing unit configured to stop transmission of the radio wave from the antenna when the determination unit determines that the accuracy of detection of the longitude, the latitude, and the altitude is not in the necessary and sufficient level, wherein
the detection unit
detects the longitude, the latitude, the altitude, the azimuth, and the inclination of the antenna also after elapse of a predetermined time after the stop processing unit stops the transmission of the radio wave from the antenna, and
the drive unit
drives the antenna to adjust the azimuth angle, the elevation angle, and the polarization angle of the antenna to the communication satellite in accordance with the longitude, the latitude, the altitude, the azimuth, and the inclination of the antenna detected by the detection unit after elapse of the predetermined time after the stop processing unit stops the transmission of the radio wave from the antenna.

2. The satellite communication earth station according to claim 1, wherein
the determination information acquisition unit
acquires, as the determination information, at least any of the number of the communication satellites that receive a radio wave, a reception level of the radio wave received from the communication satellite, and the elevation angle relative to the communication satellite.

3. A communication control method for controlling communication of a satellite communication earth station for adjusting an azimuth angle, an elevation angle, and a polarization angle of an antenna to a communication satellite and then transmitting and receiving a radio wave between the antenna and the communication satellite, the communication control method comprising:
detecting a longitude, a latitude, an altitude, an azimuth, and an inclination of the antenna;
driving the antenna to adjust the azimuth angle, the elevation angle, and the polarization angle of the antenna to the communication satellite in accordance with the longitude, the latitude, the altitude, the azimuth, or the inclination detected;
acquiring determination information necessary to determine accuracy of detection of the longitude, the latitude, and the altitude of the antenna detected;
determining whether the accuracy of detection of the longitude, the latitude, and the altitude is in a necessary and sufficient level in accordance with the determination information acquired;
stopping transmission of the radio wave from the antenna when it is determined that the accuracy of detection of the longitude, the latitude, and the altitude is not in the necessary and sufficient level;
detecting the longitude, the latitude, the altitude, the azimuth, and the inclination of the antenna also after elapse of a predetermined time after the transmission of the radio wave from the antenna is stopped; and
driving the antenna to adjust the azimuth angle, the elevation angle, and the polarization angle of the antenna to the communication satellite in accordance with the longitude, the latitude, the altitude, the azimuth, and the inclination of the antenna detected after elapse of the predetermined time after the transmission of the radio wave from the antenna is stopped.

4. The communication control method according to claim 3, wherein
in the acquiring,
at least any of the number of the communication satellites that receive a radio wave, a reception level of the radio wave received from the communication satellite, and an elevation angle relative to the communication satellite is acquired as the determination information.
